(19) United States
(12) Patent Application Publication
(10) Pub. No.: US 2012/0303709 A1
(43) Pub. Date: Nov. 29, 2012

(54) CONFERENCE ASSISTANCE SYSTEM, DATA PROCESSING APPARATUS AND RECORDING MEDIUM

(75) Inventors: Takeshi FUJITA, Tokyo (JP); Masateru KUMAGAI, Kanagawa (JP); Kei OYAMADA, Kanagawa (JP); Yasuharu YANAMURA, Kanagawa (JP); Nahoko YANO, Kanagawa (JP)

(73) Assignee: RICOH COMPANY, LTD., Tokyo (JP)

(21) Appl. No.: 13/473,708

(22) Filed: May 17, 2012

(30) Foreign Application Priority Data
May 27, 2011 (JP) 2011-119603

(51) Int. Cl. G06F 15/16

(52) U.S. Cl. 709/204

(57) ABSTRACT

A conference assistance system including one or more of a display terminal that displays data of a document; a display input device that displays added data input by a user; a positional information obtaining device that obtains positional information of the display terminal and the display input device; and a data processing apparatus that calculates the positional relationship of the display terminal and the display input device based on the positional information of the display terminal and the display input device, specifies the display terminal to which the added data is to be delivered based on the positional relationship of the display terminal and the display input device, and delivers the added data to the specified display terminal to have the display terminal display the added data, the display terminal, the display input device, which are capable of communicating via a network.

### BACKGROUND OF THE INVENTION

1. Field of the Invention

The present invention relates to a conference assistance system, a data processing apparatus and a recording medium.

2. Description of the Related Art

Conventionally, when having a conference at an office or the like, a presenter who performs a presentation in the conference prepares paper documents or data of documents and distributes or displays them on a display such as a projector or the like, in order for participants who join the conference to understand the content of the conference more easily.

Recently, because of a lowered cost for personal computers (PC) or the like, an increased speed of networks, or the like, intranets are rapidly being developed. Therefore, a case where a file of documents for the conference or the like prepared by the presenter is sent to the participants of the conference in data form is increasing.

An electronic conference system in which a file of the documents for the conference or the like is shared by using a PC is previously known (Patent Document 1, for example). In this system, a presenter sends files of documents in data form to the PCs of participants, or the participants download the data of the documents in data form in a conference place such as a conference room or the like.

Here, there is a case where a presenter writes information on a whiteboard or the like in addition to displaying a document, which is previously prepared, on a display such as a projector or the like during the presentation. Different from the document previously prepared by the presenter, the information written on the whiteboard or the like is prepared during the conference. Therefore, there is a problem that the participants cannot read the information written on the whiteboard or the like depending on the place where the participant sits in the conference place such as the conference room or the like. It means that in the conventional electronic conference system, information which is prepared during the conference such as information written on the whiteboard or the like may not be shared to the participants.

### PATENT DOCUMENT

[Patent Document 1] Japanese Laid-open Patent Publication No. 2005-284344

### SUMMARY OF THE INVENTION

The present invention is made in light of the above problems, and provides a conference assistance system, a data processing apparatus and a recording medium having recorded thereon a document delivering program capable of sharing information generated during the conference to participants.

According to an embodiment, there is provided a conference assistance system including one or more of a display terminal that displays data of a document; a display input device that displays added data input by a user; a positional information obtaining device that obtains positional information of the display terminal and the display input device; and a data processing apparatus that calculates the positional relationship of the display terminal and the display input device based on the positional information of the display terminal and the display input device, specifies the display terminal to which the added data is to be delivered based on the positional relationship of the display terminal and the display input device, and delivers the added data to the specified display terminal to have the display terminal display the added data, the display terminal, the display input device, the positional information obtaining device, and the data processing apparatus being capable of communicating via a network.

According to another embodiment, there is provided a data processing apparatus including a calculation unit that calculates the positional relationship of one of more of a display terminal that displays data of a document and a display input device that displays added data input by a user based on the positional information of the display terminal and the display input device; a specifying unit that specifies the display terminal to which the added data is to be delivered based on the positional relationship of the display terminal and the display input device; and a delivering unit that delivers the added data to the specified display terminal to have the display terminal display the added data.

According to another embodiment, there is provided a non-transitory computer-readable recording medium having recorded thereon a document delivering program that causes a computer to execute modules including a calculation module that calculates the positional relationship of one of more of a display terminal that displays data of a document and a display input device that displays added data input by a user based on the positional information of the display terminal and the display input device; a specifying module that specifies the display terminal to which the added data is to be delivered based on the positional relationship of the display terminal and the display input device; and a delivering module that delivers the added data to the specified display terminal to have the display terminal display the added data.

Note that also arbitrary combinations of the above-described constituents, and any exchanges of expressions in the present invention, made among method, device, system, recording medium, computer program, data structure and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a block diagram showing an example of a structure of a conference assistance system of an embodiment;

FIG. 2 is a block diagram showing an example of the hardware structure of a personal computer actualizing a conference assistance server;

FIG. 3 is a block diagram showing an example of the functional structure of the conference assistance server;

FIG. 4 is a sequence diagram showing an example of the operation between modules of the conference assistance server;

FIG. 5 is a schematic view showing an example of the operation of the conference assistance system of an embodiment;

FIG. 6 is a diagram showing an example of the structure of a terminal management table;

FIG. 7 is a flowchart showing an example of the process steps of the conference assistance server;

FIG. 8 is a schematic view showing another example of the operation of a conference assistance system of an embodiment;

FIG. 9 is a schematic view showing an example of a conference assistance system in which transmitters are provided at interface of each area;

FIG. 10 is a flowchart showing an example of the process steps in which whether a display terminal is the delivering target of the added information is determined by using the distance mode or the area mode;

FIG. 11 is a schematic view showing another example of the operation of a conference assistance system of an embodiment;

FIG. 12 is a diagram showing another example of the structure of a terminal management table;

FIG. 13 is a diagram showing an example of the structure of a data item “delivering target flag”;

FIG. 14 is a schematic view showing an example of the operation of editing the added information into the information style corresponding to the specification of the display terminal;

FIG. 15 is a schematic view showing another example of the operation of editing the added information into the information style corresponding to the specification of the display terminal; and

FIG. 16 is a flowchart showing an example of the process steps in which the information style of the added information is determined in accordance with the specification of the display terminal.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

In the following, a conference assistance system may also be referred to as a “presentation system”.

A conference assistance system of the embodiment uses display terminals of participants which are connected via a network. The conference assistance system of the embodiment recognizes a position of a whiteboard or the like on which information is written or shown in a conference and positions of the display terminals held by the participants, and specifies the display terminals to which information written on the whiteboard or the like (hereinafter, referred to as “added information” or “added data”) is to be delivered based on the positional relationship (for example, distance, direction or the like) of the whiteboard or the like and the display terminals. Here, the specified display terminals are display terminals held by the participants who are predicted to be difficult to read the added information written on the whiteboard or the like based on the positional relationship of the whiteboard or the like and the display terminals. Then, the added information can be shared by the participants as the conference assistance system delivers the added information (added data) to the display terminals which are specified as the display terminals to which the added information is to be delivered, when the added information is generated during the conference.

### (Entire Structure of the Conference Assistance System)

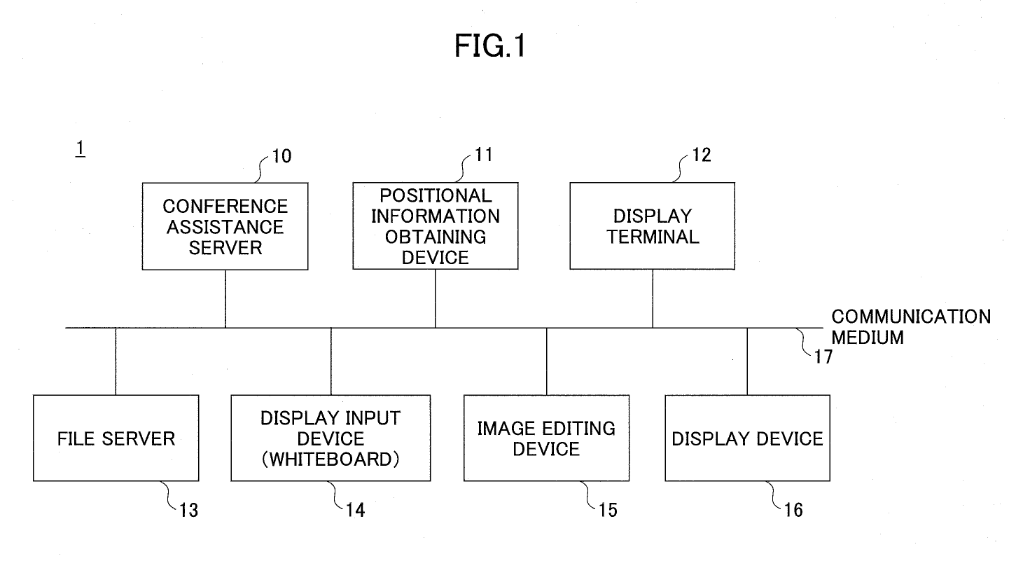

FIG. 1 is a block diagram showing an example of a structure of a conference assistance system 1 of the embodiment.

The conference assistance system 1 of the embodiment includes a conference assistance server 10, a positional information obtaining device 11, a display terminal 12, a file server 13, a display input device 14 (whiteboard), an image editing device 15, and a display device 16 which are connected via a communication medium (network) 17 such as a local area network (LAN) or the like.

The conference assistance server 10 collects added information and controls delivery of the added information. Here, the conference assistance server 10 is not limited to a device so called a “server”. The conference assistance server 10 may be, for example, a software module.

The positional information obtaining device 11 obtains positional information (coordinate information or the like) of the display terminal 12 and the display input device 14 transmitted by the display terminal 12 and the display input device 14, which will be explained later. The positional information obtaining device 11 transfers the obtained positional information of the display terminal 12 and the display input device 14 to the conference assistance server 10.

The display terminal 12 is held by a participant of a conference or the like, and receives and displays a file of a document for the conference or the like and a file of the added information. The conference assistance system may include the plural display terminals 12 corresponding to the number of the participants, and the plural display terminals 12 are connected to the network 17. The display terminal 12 is, for example, a personal computer (PC), a tablet type computer or the like. Further, the display terminal 12 transmits positional information (coordinate information or the like) of its own. The display terminal 12 uses a conventional technique for obtaining the positional information of its own such as Global Positioning System (GPS) or the like, for example. Alternatively, the display terminal 12 may use a conventional system using sound (such as sound with frequency inaudible to humans or the like) for obtaining the positional information of its own. The display terminals 12 may be prepared by a host side of the conference or the like. In this case, the participants can use the display terminals 12 prepared by the host side.

The file server 13 stores files including files of documents for the conference or the like (presentation documents) which are prepared by the presenter prior to the conference or files of the added information which are input to the display input device 14 during the conference.

The display input device 14 distinguishes the added information which are input (written) during the conference from the presentation documents which are prepared prior to the conference and sends the added information to the conference assistance server 10. The display input device 14 is a device capable of being connected to the network 17 such as a whiteboard (electric blackboard), a multi-digital board (MDB) or the like. In other words, the display input device 14 is capable of obtaining the information written during the conference in data form.

The image editing device 15 converts or edits data or an image of the added information, as will be explained later.

The display device 16 is a display such as a projector or the like. The display device 16 displays the presentation documents for all of the participants. The display device 16 displays the presentation documents at a size large enough so that all of the participants can see the content in accordance with the size of the conference room, for example. The network 17 includes a wired and wireless network.

The conference assistance system 1 shown in FIG. 1 is just an example, and a function of the conference assistance server 10 may be performed by the display input device 14 or the display device 16. Further, for the conference assistance system 1 shown in FIG. 1, a function of the conference assistance server 10, the file server 13 or the image editing device 15 may be performed by the display input device 14 or the display device 16. Further, for the conference assistance system 1 shown in FIG. 1, the conference assistance server 10, the file server 13 and the image editing device 15 may be actualized by a single PC or the like.

The added information which is written on the display input device 14 is delivered to the display terminals 12 specified by the conference assistance server 10 as will be explained later and displayed on the corresponding display terminals 12. The conference assistance server 10 determines whether to deliver the added information to the display terminals 12 based on the positional relationship of the corresponding display terminal 12 and the display input device 14 obtained by the positional information obtaining device 11. Here, the added information input from the display input device 14 is delivered to the display terminals 12 after being appropriately converted by the image editing device 15 in accordance with the specification of the corresponding display terminal 12.

### (Hardware Structure of the Conference Assistance Server 10)

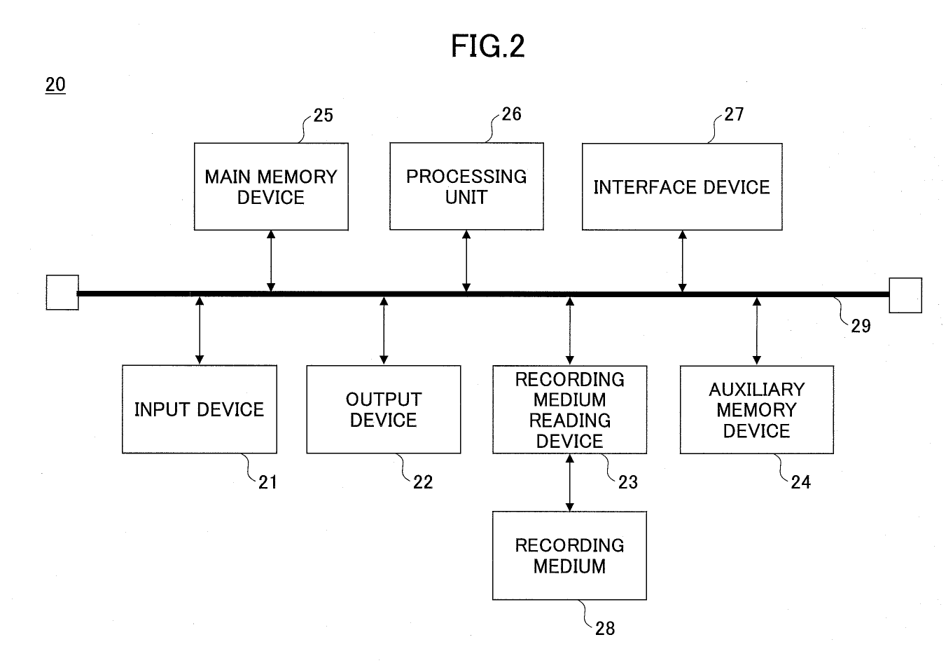

The conference assistance server 10 is actualized by a PC having the hardware structure shown in FIG. 2, for example. FIG. 2 is a block diagram showing an example of the hardware structure of the PC. The PC 20 shown in FIG. 2 includes an input device 21, an output device 22, a recording medium reading device 23, an auxiliary memory device 24, a main memory device 25, a processing unit 26 and an interface device 27 which are connected with each other via a bus 29.

The input device 21 is a keyboard, a mouse or the like. The input device 21 is used for inputting various signals. The output device 22 is a display device or the like. The output device 22 is used for displaying various windows, data or the like. The interface device 27 is a modem, a LAN card or the like. The interface device 27 is used for connecting to the network 17.

The function of the conference assistance server 10 may be actualized by a document delivering program installed in the PC 20. The document delivering program installed in the PC 20 is at least a part of the various programs which control the PC 20. The document delivering program is provided by distributing a recording medium 28 in which the document delivering program is stored or by downloading via the network 17 or the like.

For the recording medium 28, various types of recording medium may be used such as a recording medium that optically, electrically or magnetically stores information such as a CD-ROM, a flexible disk, a magneto-optical disk or the like, a recording medium that electrically stores information such as a ROM, a flash memory or the like, or the like.

For the case where the document delivering program is stored in the recording medium 28, when the recording medium 28 is set in the recording medium reading device 23, the document delivering program is installed in the auxiliary memory device 24 from the recording medium 28 via the recording medium reading device 23.

For the case where the document delivering program is downloaded from the network 17 or the like, the document delivering program is installed in the auxiliary memory device 24 via the interface device 27. The auxiliary memory device 24 stores necessary files and data or the like in addition to the installed document delivering program.

When the document delivering program is activated, the main memory device 25 reads out the document delivering program from the auxiliary memory device 24 and stores it. Then, the processing unit 26 actualizes various processes, which will be explained later, in accordance with the document delivering program stored in the main memory device 25.

Similarly, the file server 13 and the image editing device 15 are actualized by a PC as the PC 20 shown in FIG. 2, for example.

### (Functional Structure of the Conference Assistance Server 10)

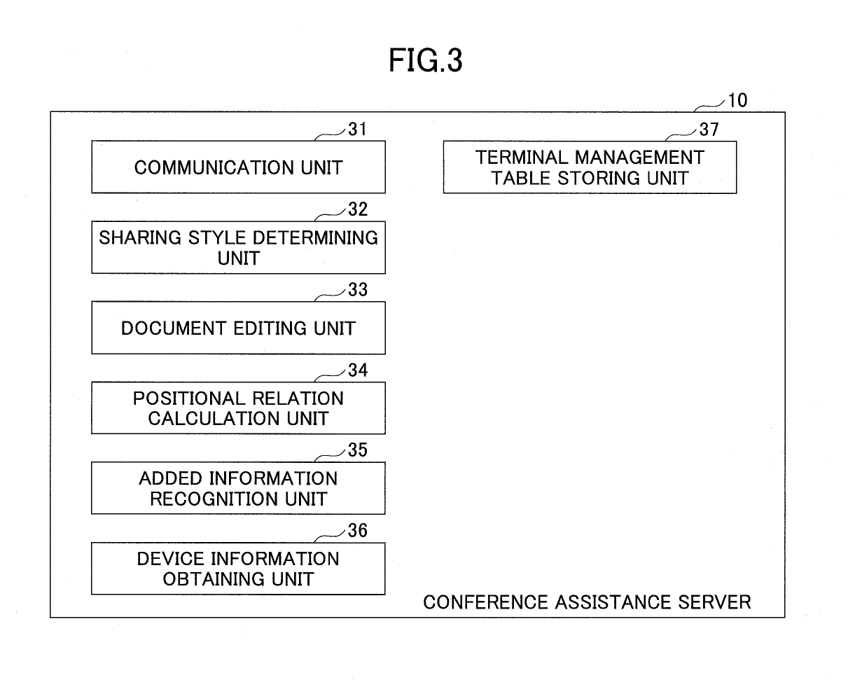

The conference assistance server 10, for example, is actualized by functional components shown in FIG. 3. FIG. 3 is a block diagram showing an example of the functional structure of the conference assistance server 10. The document delivering program is installed in the conference assistance server 10 as explained above.

The conference assistance server 10 includes modules such as a communication unit 31, a sharing style determining unit 32, a document editing unit 33, a positional relation calculation unit 34, an added information recognition unit 35, a device information obtaining unit 36 and a terminal management table storing unit 37 which are actualized by performing the document delivering program.

The communication unit 31 controls network connections between the display terminals 12, and the positional information obtaining device 11, the file server 13, the display input device 14, the image editing device 15, and the display device 16, which are processing servers or the like.

The sharing style determining unit 32 specifies the display terminals 12 to which the added information is to be delivered and determines an information style of the added information for each of the specified display terminals 12, which will be explained later in detail.

The sharing style determining unit 32 reports a specification of each of the display terminals 12 to the document editing unit 33. The document editing unit 33 determines the information style of the added information in accordance with the specification of each of the display terminals 12. The document editing unit 33 reports the determined information style of the added information to the sharing style determining unit 32.

The positional relation calculation unit 34 calculates positional relationships of the display terminals 12 and the display input device 14 from the obtained positional information of the display terminals 12 and the display input device 14. The positional relation calculation unit 34 reports the calculated positional relationship of each of the display terminals 12 and the display input device 14 to the sharing style determining unit 32.

When the added information recognition unit 35 recognizes the added information input in the display input device 14, the added information recognition unit 35 transfers the added information to the sharing style determining unit 32.

The device information obtaining unit 36 obtains device structure information (device information) of each of the display terminals 12 and the display input device 14. The device information obtaining unit 36 reports the device information to the sharing style determining unit 32.

The terminal management table storing unit 37 stores a terminal management table, which will be explained later.

### (Operation Between Modules of the Conference Assistance Server 10)

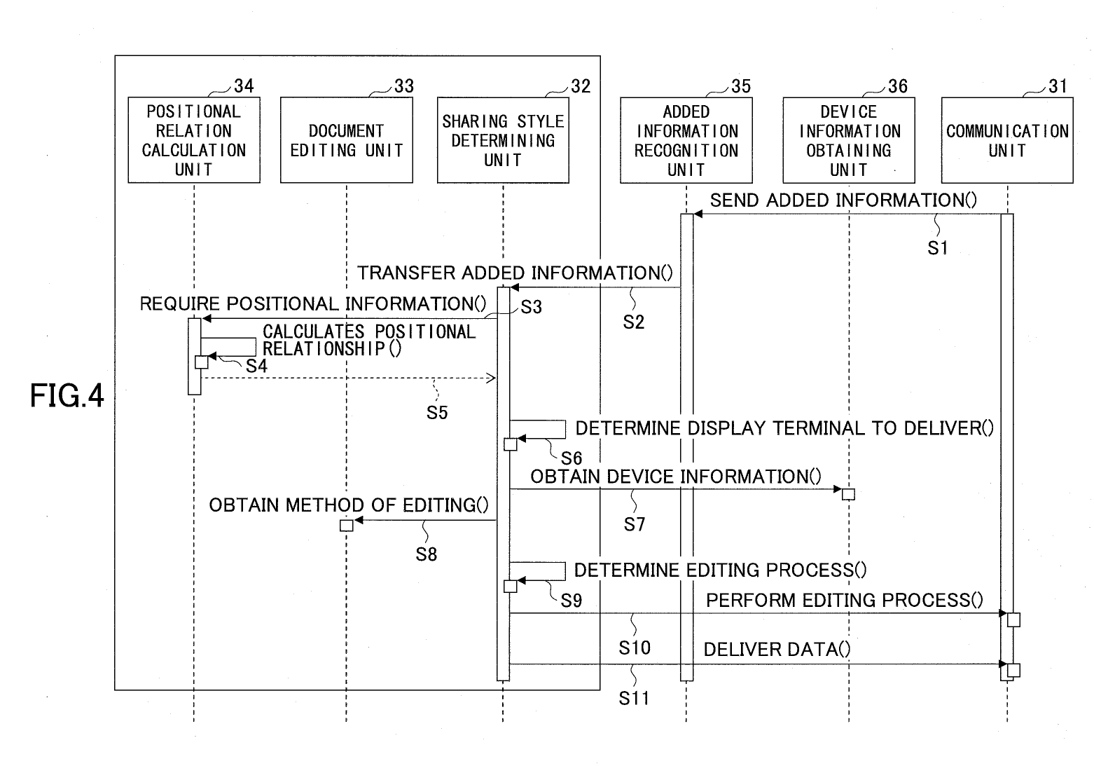

FIG. 4 is a sequence diagram showing an example of the operation between the modules of the conference assistance server 10. The added information is directly obtained from the display input device 14, which is a whiteboard or the like, or via the file server 13. In the following, it is assumed that the added information is directly obtained from the display input device 14.

In step S1, the communication unit 31 sends the added information obtained from the display input device 14 to the added information recognition unit 35. In step S2, the added information recognition unit 35 transfers the sent added information to the sharing style determining unit 32. In step S3, the sharing style determining unit 32 requires the positional relation calculation unit 34 to obtain positional information.

In step S4, the positional relation calculation unit 34 obtains positional information of the display terminal 12 and the display input device 14 from the terminal management table stored in the terminal management table storing unit 37, and calculates the positional relationship of the display terminal 12 and the display input device 14. In step S5, the positional relation calculation unit 34 sends the calculated positional relationship of the display terminal 12 and the display input device 14 to the sharing style determining unit 32.

In step S6, the sharing style determining unit 32 specifies (determines) the display terminals 12 to which the added information is to be delivered based on the positional relationship of the display terminal 12 and the display input device 14. The operation of step S6 will be explained later in detail.

In step S7, the sharing style determining unit 32 requires the device information obtaining unit 36 to obtain the device information of the display terminal 12 specified as the display terminal 12 to which the added information is to be sent (which will be referred to as a “delivering target of the added information” hereinafter, and obtains the device information of the display terminals 12 specified as the delivering target of the added information.

In step S8, the sharing style determining unit 32 has the document editing unit 33 determine the information style of the added information in accordance with the specification of the display terminal 12. The document editing unit 33 determines the information style of the added information by having the specification included in the device information of the display terminal 12 specified as the delivering target of the added information as an argument. The document editing unit 33 determines the information style of the added information in accordance with the specification, and reports it to the sharing style determining unit 32 as a method of editing the added information. The document editing unit 33 may determine the information style of the added information in accordance with the specification of the display terminal 12 by using a table in which the specification and the information style of the added information are in correspondence with each other, for example.

In step S9, the sharing style determining unit 32 determines an editing process for converting the information style of the added information in accordance with the specification of the display terminal 12 based on the method of editing the added information reported by the document editing unit 33, for each of the display terminals 12 to which the added information is to be delivered.

In step S10, the sharing style determining unit 32 has the image editing device 15 execute the editing process for converting the information style of the added information in accordance with the specification of the display terminal 12 via the communication unit 31. In step S11, the sharing style determining unit 32 delivers the added information which is converted to the information style in accordance with the specification of the display terminal 12 to each of the display terminals 12 via the communication unit 31.

### (An Example of the Operation of the Conference Assistance System)

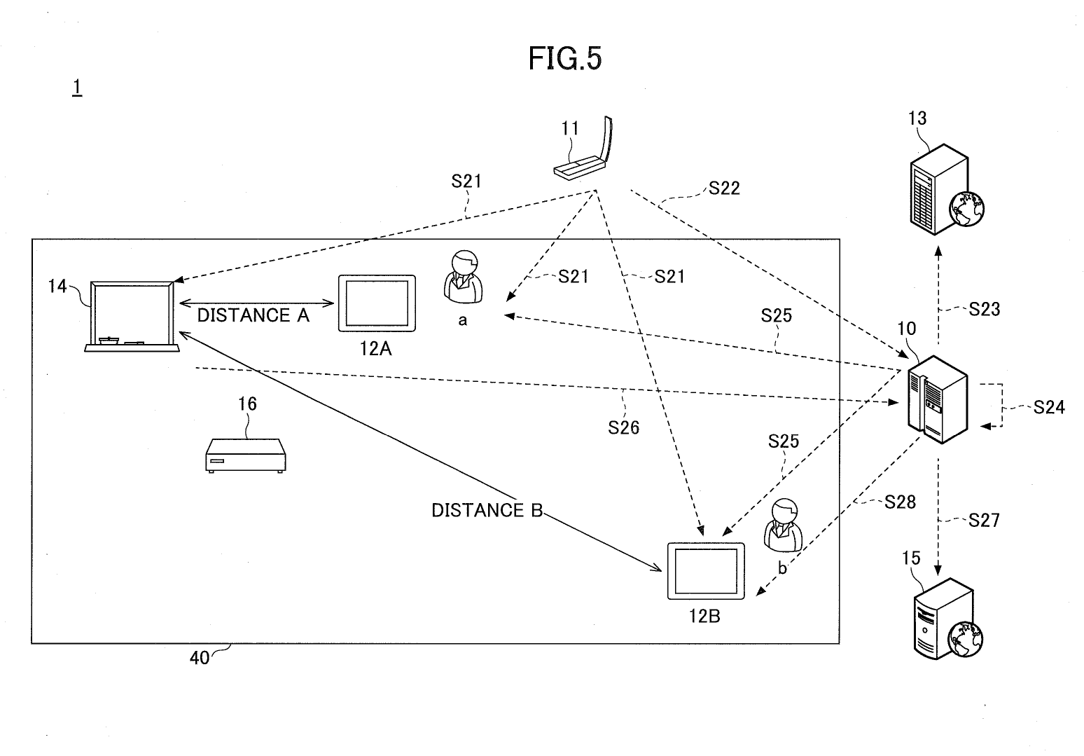

FIG. 5 is a schematic view showing an example of the operation of the conference assistance system 1 of the embodiment.

The conference assistance system 1 shown in FIG. 5 is configured to deliver the added information to the display terminal 12 which is positioned further than a predetermined distance from the display input device 14.

A display terminal 12A held by a participant “a”, a display terminal 12B held by a participant “b”, the display input device 14, and the display device 16 exist at a conference place (presentation place of the like) 40 shown in FIG. 5. The positional information obtaining device 11 exists at a position capable of obtaining the positional information transmitted by the display terminal 12A or the like which exist at the conference place 40. Here, the conference assistance server 10, the file server 13 and the image editing device 15 may exist at the conference place 40, or may exist at other places.

In step S21, the positional information obtaining device 11 obtains positional information, address information and device information transmitted by the display terminals 12A and 12B, and the display input device 14. The address information is information that uniquely identifies the display terminal 12A, the display terminal 12B, the display input device 14 and the like. The device information is information that expresses specifications of the display terminal 12A, the display terminal 12B, the display input device 14 and the like, for example.

In step S22, the positional information obtaining device 11 transfers the positional information, the address information and the device information obtained from the display terminal 12A, the display terminal 12B and the display input device 14 to the conference assistance server 10. The conference assistance server 10 obtains the positional information, the address information and the device information of the display terminal 12A, the display terminal 12B and the display input device 14.

In step S23, the conference assistance server 10 obtains a file of the presentation documents from the file server 13. Then, in step S24, the conference assistance server 10 calculates the distance “A” between the display terminal 12A and the display input device 14 (positional relationship) and the distance “B” between the display terminal 12B and the display input device 14 (positional relationship) based on the positional information of the display terminal 12A, the display terminal 12B and the display input device 14.

The conference assistance server 10 specifies the display terminal 12A as the delivering target of the added information when the calculated distance “A” between the display terminal 12A and the display input device 14 exceeds the predetermined threshold value. Similarly, the conference assistance server 10 specifies the display terminal 12B as the delivering target of the added information when the calculated distance “B” between the display terminal 12B and the display input device 14 exceeds the predetermined threshold value.

The predetermined threshold value may be stored by the conference assistance server 10, for example. The predetermined threshold value may be varied in accordance with the conference place, for example. The predetermined threshold value may be a specific distance value such as 10 m or the like, for example. The conference assistance server 10 stores the information such as the distance “A” between the display terminal 12A and the display input device 14, the distance “B” between the display terminal 12B and the display input device 14, and whether the display terminal 12A and the display terminal 12B are the delivering target of the added information in the terminal management table stored in the terminal management table storing unit 37.

It is assumed, for example, in the conference assistance system 1 shown in FIG. 5, the positional information of the display terminal 12A, the display terminal 12B and the display input device 14 are (0, 0), (1, 0) and (9, 5), respectively. In this case, the calculated distance “A” between the display terminal 12A and the display input device 14 becomes 1 m. Further, the calculated distance “B” between the display terminal 12B and the display input device 14 becomes about 10.3 m.

The distance “A” is less than the predetermined threshold value 10 m. Thus, the conference assistance server 10 does not specify the display terminal 12A as the delivering target of the added information. On the other hand, the distance “B” exceeds the predetermined threshold value 10 m. Thus, the conference assistance server 10 specifies the display terminal 12B as the delivering target of the added information.

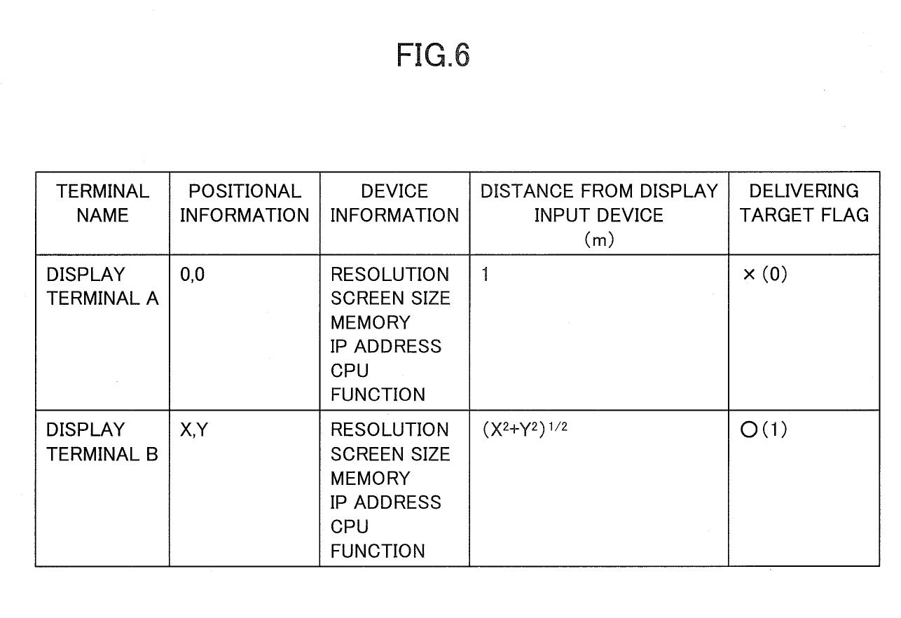

Next, the terminal management table stored in the terminal management table storing unit 37 is explained with reference to FIG. 6. FIG. 6 is a diagram showing an example of the structure of the terminal management table. The terminal management table shown in FIG. 6 includes terminal name, positional information, device information, distance from the display input device, and delivering target flag as data items. The terminal name expresses a name of the device such as the display terminal 12A or the like. The positional information expresses the positional information (coordinate information) of the device such as the display terminal 12A or the like.

The device information expresses the specification of the device such as the display terminal 12A or the like. The specification of the device includes information such as resolution, screen size, memory, CPU or the like. The distance from the display input device expresses the distance between the device such as the display terminal 12A or the like and the display input device 14. The delivering target flag expresses whether it is specified as the delivering target of the added information or not. For the example of the terminal management table shown in FIG. 6, the delivering target flag for the display terminal 12B is shown as effective “1” which means that the display terminal 12B is specified as the delivering target of the added information.

Here, the position of the device which is previously set in the conference place 40 such as the display input device 14 may be previously registered in the conference assistance system 1, different from the display terminals 12A and 12B the positions of which are automatically detected during the conference. Further, the timing of detecting the positions of the devices such as the display terminal 12A or the like may be selected from the following two methods, for example. The positions of the devices such as the display terminal 12A or the like may be detected at a predetermined interval (polling). Alternatively, the positions of the devices such as the display terminal 12A or the like may be detected when the device is not operated. With these timings, unnecessary control can be reduced in accordance with the situation during the conference so that performance can be improved.

Referring back to FIG. 5, in step S25, the conference assistance server 10 delivers a file of presentation documents to the display terminals 12A and 12B regardless of the delivering target flag. This step may be performed prior to the conference as explained above.

The display input device 14 recognizes added information which is input (written) during the conference. In step S26, the display input device 14 transfers the recognized added information to the conference assistance server 10.

When the added information is transferred, the conference assistance server 10 determines the display terminal 12B to which the added information is to be delivered based on the delivering target flag of the terminal management table, and obtains the device information of the display terminal 12B from the terminal management table.

The conference assistance server 10 determines the information style of the added information (the method of editing the added information) based on the specification of the device information of the display terminal 12B. The conference assistance server 10 determines an editing process for converting the information style of the added information corresponding to the specification of the display terminal 12B in accordance with the method of editing the added information.

In step S27, the conference assistance server 10 has the image editing device 15 execute the editing process for converting the added information into the information style in accordance with the specification of the display terminal 12B. The image editing device 15 performs the editing process for the added information, and converts the added information into the information style corresponding to the specification of the display terminal 12B. In other words, the image editing device 15 converts the added information into the information style which can reduce a processing load at the display terminal 12B.

For example, when the resolution of the input image data of the display input device 14 is “1920×1080 dpi/color”, and the resolution of the display terminal 12B is “800×600 dpi/monochrome”, if the file of the added information itself is delivered to the display terminal 12B, it is necessary for the display terminal 12B to perform a data conversion process such as reducing data or the like. In this case, for actualizing a real time operation, the display terminal 12B is necessary to have high performance. Further, in this case, data which is unnecessary for displaying on the display terminal 12B is transmitted through the network 17, which may cause a delay in total communications of the conference assistance system 1.

The conference assistance system 1 of the embodiment previously obtains information about the specification of the display terminal 12B to which the added information is to be delivered. Then, the added information is edited into the information style suitable for the display terminal 12B in accordance with the specification of the display terminal 12B by the image editing device 15 which is dedicated for editing. Thus, the data which is unnecessary for displaying on the display terminal 12B is not transmitted through the network 17 and the data conversion process at the display terminal 12B is not necessary.

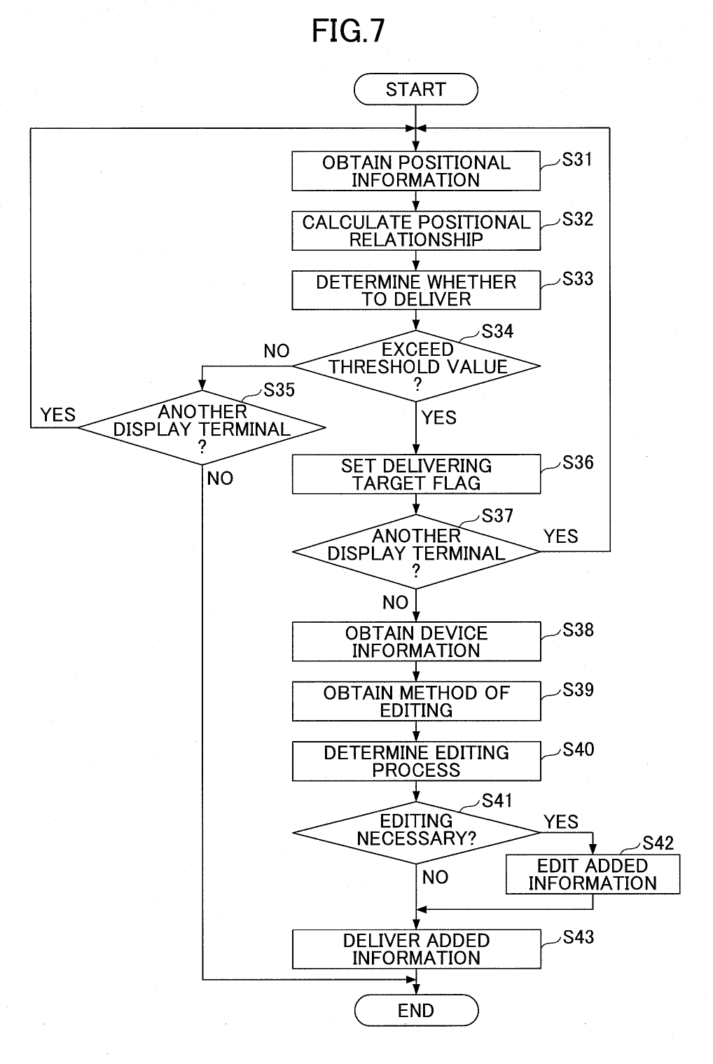

In step S28, the conference assistance server 10 delivers the added information which is converted into the information style in accordance with the specification of the display terminal 12B by the image editing device 15 to the display terminal 12B. The operation of the conference assistance server 10 is further explained with reference to FIG. 7.

FIG. 7 is a flowchart showing an example of the process steps of the conference assistance server.

In step S31, the conference assistance server 10 obtains the positional information of the display terminal 12 and the display input device 14.

In step S32, the conference assistance server 10 calculates the distance between the display terminal 12 and the display input device 14 based on the positional information of the display terminal 12 and the display input device 14.

In step S33, the conference assistance server 10 determines whether the display terminal 12 is the terminal to which the added information is to be delivered.

In step S34, the conference assistance server 10 determines whether the distance between the display terminal 12 and the display input device 14 exceeds the predetermined threshold value. When it is less than or equal to the threshold value (NO in step S34), the conference assistance server 10 determines whether another display terminal 12 exists in step S35.

When another display terminal 12 exists (YES in step S35), the conference assistance server 10 returns back to step S31 to continue the processes. When there is not another display terminal 12 (NO in step S35), the conference assistance server 10 terminates the processes of the flowchart in FIG. 7.

In step S34, when the distance exceeds the threshold value (YES in step S34), the conference assistance server 10 performs the process of step S36. In step S36, the conference assistance server 10 sets the delivering target flag of the display terminal 12 “on” to specify the display terminal 12 as the delivering target of the added information.

Then in step S37, the conference assistance server 10 determines whether another display terminal 12 exists. When another display terminal 12 exists (YES in step S37), the conference assistance server 10 returns back to step S31 to continue the processes.

When there is not another display terminal 12 (NO in step S37), the conference assistance server 10 obtains the device information of the display terminal 12 and the display input device 14 in step S38.

In step S39, the conference assistance server 10 determines (obtains) the method of editing the added information in accordance with the specification of the display terminal 12. In step S40, the conference assistance server 10 determines an editing process for each of the display terminals 12 specified as the delivering target of the added information in accordance with the method of editing the added information.

Then, in step S41, when it is necessary to edit the added information for the display terminal 12 (YES in step S41), the conference assistance server 10 has the image editing device 15 edit the added information in step S42, and delivers (transfers) the added data in step S43. When it is unnecessary to edit the added information for the display terminal 12 in step S41 (NO in step S41), the conference assistance server 10 delivers (transfers) the added data in step S43.

### (Another Example of the Operation of the Conference Assistance System)

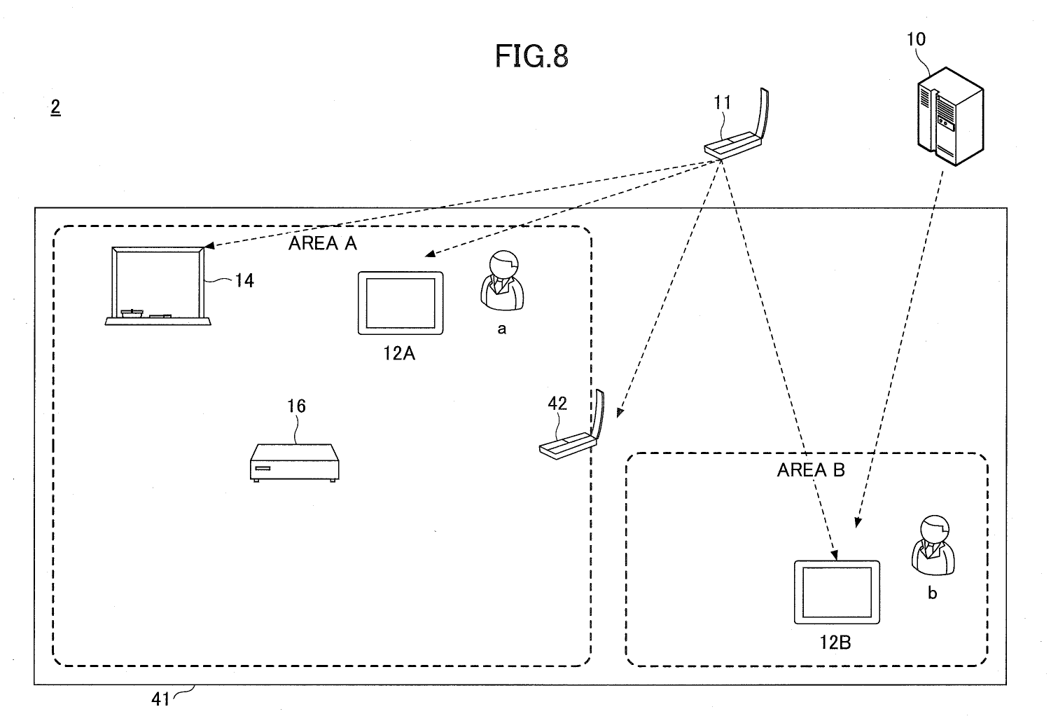

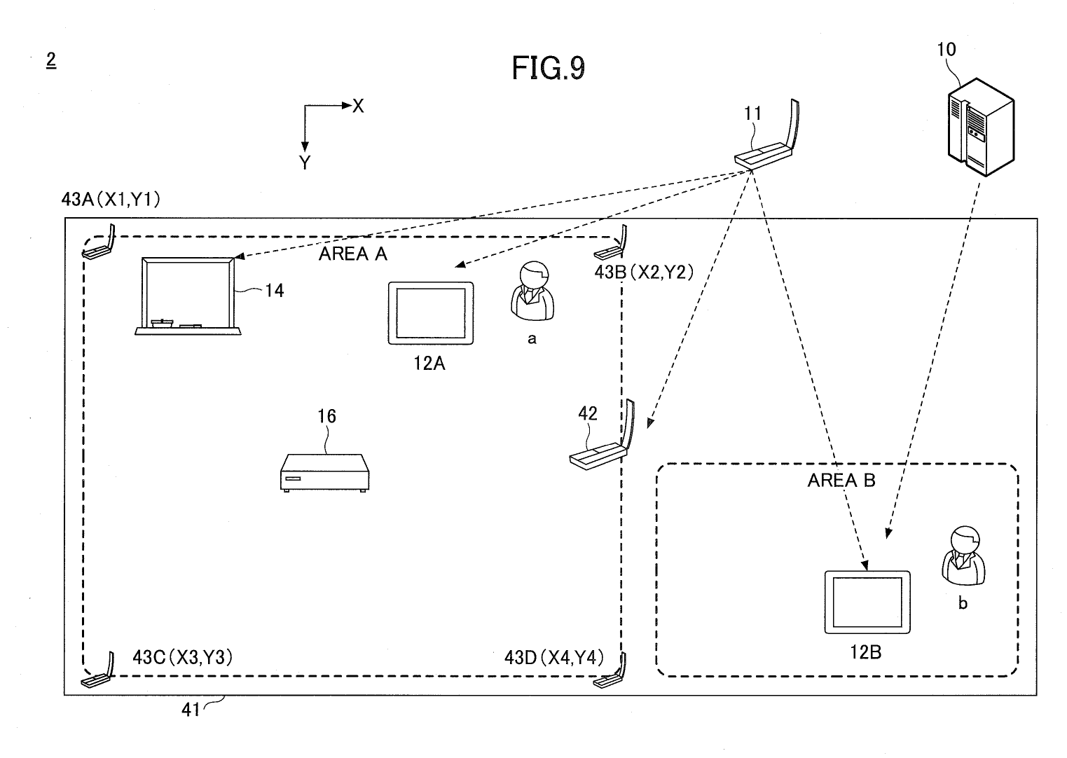

FIG. 8 is a schematic view showing another example of the operation of a conference assistance system 2 of the embodiment. The conference assistance system 2 in FIG. 8 is configured to deliver the added information to the display terminal 12 which is not included in the same area as the display input device 14. As the conference assistance system 2 shown in FIG. 9 is similar to the conference assistance system 1 shown in FIG. 5 except a part, the explanation is not repeated.

The display terminal 12A held by the participant “a”, the display terminal 12B held by the participant “b”, the display input device 14, the display device 16 and an interface transmitting device 42 exist at a conference place 41 shown in FIG. 8. The positional information obtaining device 11 exists at a position capable of obtaining the positional information transmitted by the display terminal 12A or the like which exist at the conference place 41.

Here, the conference assistance server 10, the file server 13 and the image editing device 15 may exist at the conference place 41, or may exist at other places although the file server 13 and the image editing device 15 are not shown in FIG. 8.

The conference place 41 is divided to include an area “A” and an area “B” by positional information transmitted by the interface transmitting device 42. The display terminal 12A and the display input device 14 exist in the area “A”. The display terminal 12B exists in the area “B”. For the conference assistance system 2 shown in FIG. 8, the display input device 14 does not exist in the area “B”. Therefore, for the conference assistance system 2 shown in FIG. 8, the added information is delivered to the display terminal 12B that exists in the area “B”.

In the conference assistance system 2 shown in FIG. 8, the conference assistance server 10 may determine whether the display terminal 12 is the delivering target of the added information based on whether the display terminal 12 is within an area in which the display input device 14 exists based on the obtained positional information, instead of determining based on the distance from the display input device 14. The area in which the display input device 14 exists may be previously set.

For the display terminals 12 which exist within a certain distance closer to each other, the determination whether they are the delivering targets of the added information may be the same. Therefore, the conference assistance server 10 of the conference assistance system 2 shown in FIG. 8 may determine whether the display terminals 12 are the delivering targets of the added information without calculating the positional relationship for each of the display terminals 12.

For the conference assistance system 2 shown in FIG. 8, transmitters may be provided at an interface between the areas. Then, by obtaining the positional information from the transmitters, whether the display terminals 12 are included in the same area as the display input device 14 can be determined. Here, the interface of the areas may be previously set as a fixed value. For example, when the conference is held in the same style, the interface of the areas can be set as a fixed value.

FIG. 9 is a schematic view showing an example of the conference assistance system 2 in which transmitters are provided at an interface of each of the areas. For the conference assistance system 2 shown in FIG. 9, transmitters 43A to 43D are provided at four corners of the area “A” of the conference assistance system 2 shown in FIG. 8.

In the conference assistance system 2 shown in FIG. 9, for example, it is assumed that the positional information of the transmitters 43A to 43D are (X1, Y1), (X2, Y2), (X3, Y3) and (X4, Y4), respectively. Further, it is assumed that the positional information of the display terminal 12A and the display terminal 12B are (Xa, Ya) and (Xb, Yb), respectively. Whether the display terminal 12A exists within the area “A” may be determined based on whether the positional information of the display terminal 12A, obtained by the positional information obtaining device 11, complies with the following equations (1) and (2). For the display terminal 12A, the positional information complies with the following equations (1) and (2), so that the display terminal 12A is determined to be within the area “A”.

Xa>X1 and Xa<X2 (1)

Ya>Y1 and Ya<Y3 (2)

Further, whether the display terminal 12B exists within the area “A” may be determined based on whether the positional information of the display terminal 12B, obtained by the positional information obtaining device 11, complies with the following equations (3) and (4). For the display terminal 12B, the positional information does not complies with the following equations (3) and (4), so that the display terminal 12B is determined to be not within the area “A”.

Xb>X1 and Xb<X2 (3)

Yb>Y1 and Yb<Y3 (4)

Here, although in this example, in the conference assistance system 2 shown in FIG. 9, whether the display terminal 12A or 12B exists within the area “A” is determined. However, alternatively, whether the display terminal 12A or 12B exists within the area “B” may be determined, for example. In this case, the display terminal 12B which exists within the area “B” is determined not to exist in the same area as the display input device 14. Which of the area “A” and the area “B” is selected as a reference may be determined based on the sizes of the areas, for example, to reduce the calculation amount. Further, the coordinate of the conference assistance system 2 shown in FIG. 9 is just an example, and may be altered in accordance with the conference place 41.

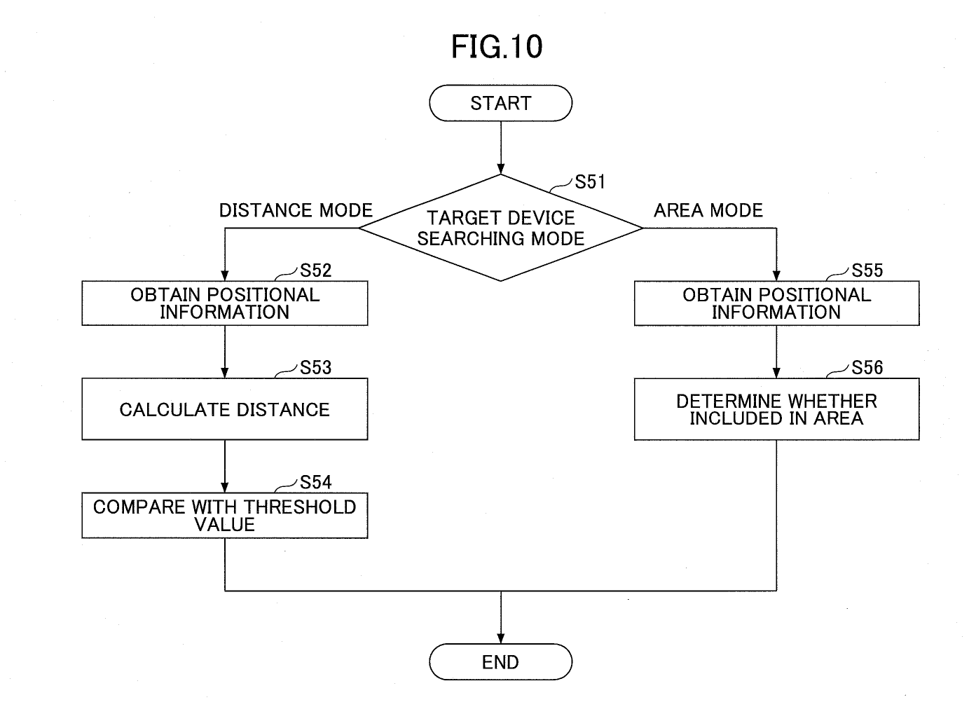

The conference assistance server 10 may determine whether the display terminal 12 is the delivering target of the added information by the distance mode or the area mode in accordance with the process steps shown in FIG. 10, for example. In the distance mode, the conference assistance server 10 determines whether the display terminal 12 is the delivering target of the added information by the method explained as the conference assistance system 1 with reference to FIG. 5. In the area mode, the conference assistance server 10 determines whether the display terminal 12 is the delivering target of the added information by the method explained as the conference assistance system 2 with reference to FIG. 8 or FIG. 9.

FIG. 10 is a flowchart showing an example of the process steps in which whether the display terminal 12 is the delivering target of the added information by using the distance mode or the area mode. FIG. 10 shows only the different parts from the flowchart shown in FIG. 7.

In step S51, the conference assistance server 10 determines whether a target device searching mode is the distance mode or the area mode. The target device searching mode expresses a method of determining whether the display terminal 12 is the delivering target of the added information. The target device searching mode may be previously set or may be set by a user for each case.

When it is determined that the target device searching mode is the distance mode, the conference assistance server 10 performs the same processes as the steps S31 to S34 shown in FIG. 7. The conference assistance server 10 obtains the positional information of the display terminal 12 and the display input device 14 in step S52. In step S53, the conference assistance server 10 calculates the distance between the display terminal 12 and the display input device 14 based on the positional information of the display terminal 12 and the display input device 14.

In step S54, the conference assistance server 10 determines whether the distance between the display terminal 12 and the display input device 14 exceeds the predetermined threshold value. When the distance exceeds the threshold value, the conference assistance server 10 determines that the display terminal 12 is the delivering target of the added information.

Further, when the target device searching mode is determined to be the area mode, the conference assistance server 10 obtains the positional information of the display terminal 12, the display input device 14 and the transmitters 43A to 43D in step S55. Then, the conference assistance server 10 determines whether the display terminal 12 is within the same area as the display input device 14 based on the positional information of the display terminal 12, the display input device 14 and the transmitters 43A to 43D, in step S56.

The conference assistance server 10 determines that the display terminal 12 as the delivering target of the added information when the display terminal 12 is not included in the same area as the display input device 14. The conference assistance server 10 performs the subsequent processes of the step S36 of FIG. 7 after the process of the step S54 or the step S56.

### (Another Example of the Operation of the Conference Assistance System)

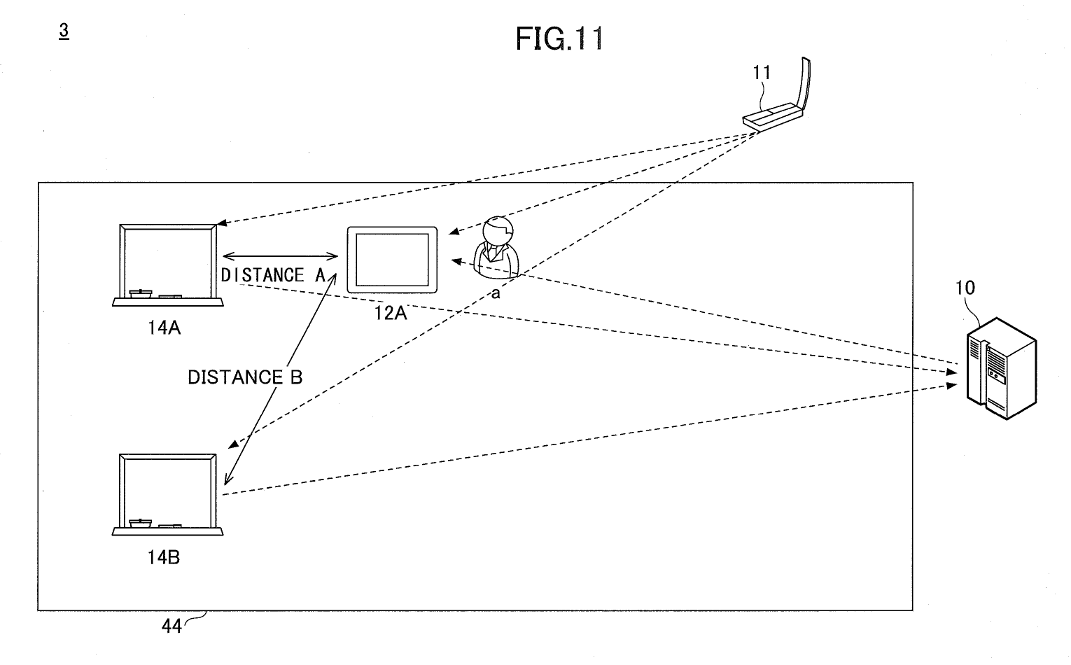

FIG. 11 is a schematic view showing another example of the operation of a conference assistance system 3 of the embodiment. The conference assistance system 3 in FIG. 11 is configured to include plural of the display input devices 14 (14A and 14B) of the conference assistance system 1 shown in FIG. 5. The display terminal 12A held by the participant A, and display input devices 14A and 14B exist at a conference place 44 shown in FIG. 11.

The conference assistance server 10 determines whether the display terminal 12A is the delivering target of the added information, similar to that explained for the conference assistance system 1 with reference to FIG. 5, between the display terminal 12A and the display input device 14A as well as between the display terminal 12A and the display input device 14B.

The terminal management table stored in the terminal management table storing unit 37 is almost the same as the terminal management table shown in FIG. 6 except that the data items “distance from display input device” and “delivering target flag” are provided for each of the display input devices 14A and 14B.

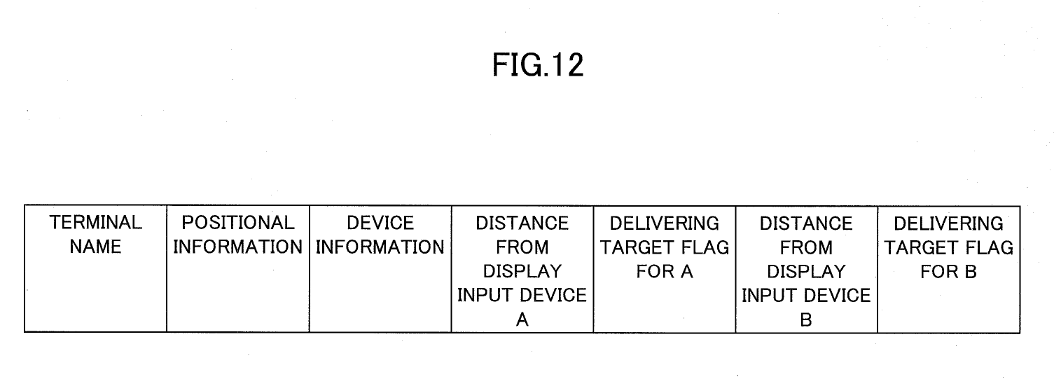

FIG. 12 is a diagram showing another example of the structure of the terminal management table. For the terminal management table shown in FIG. 12, the data items “distance from display input device” and “delivering target flag” are provided for each of the display input devices 14A and 14B.

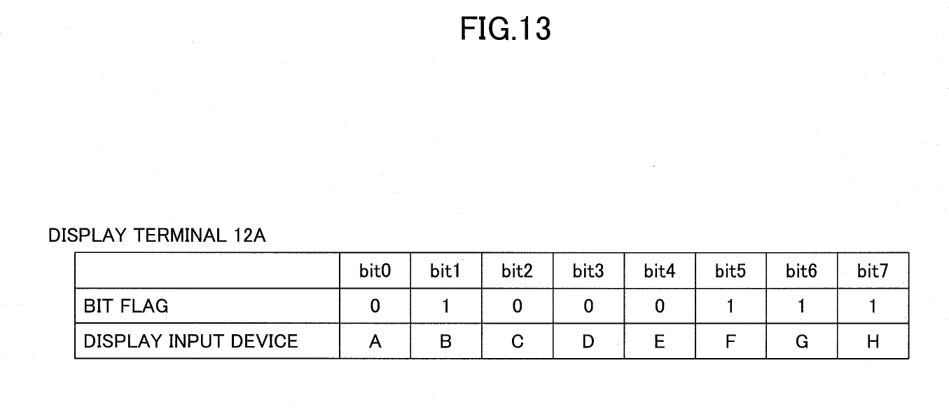

The data item “delivering target flag” may be structured as shown in FIG. 13. FIG. 13 is a diagram showing an example of the structure of the data item “delivering target flag”. FIG. 13 shows an example in which the display input devices “A” to “H” exist. In the structure shown in FIG. 13, the display input devices “A” to “H” are in correspondence with bit flags (bit 0 to 7), so that plural of the display terminals 12 can be managed with a small memory or a small amount of data. For the example shown in FIG. 13, the display terminal 12A is the delivering target of the added information for the display input devices “B”, “F”, “G” and “H”.

### (Information Style Corresponding to the Specification of the Display Terminal)

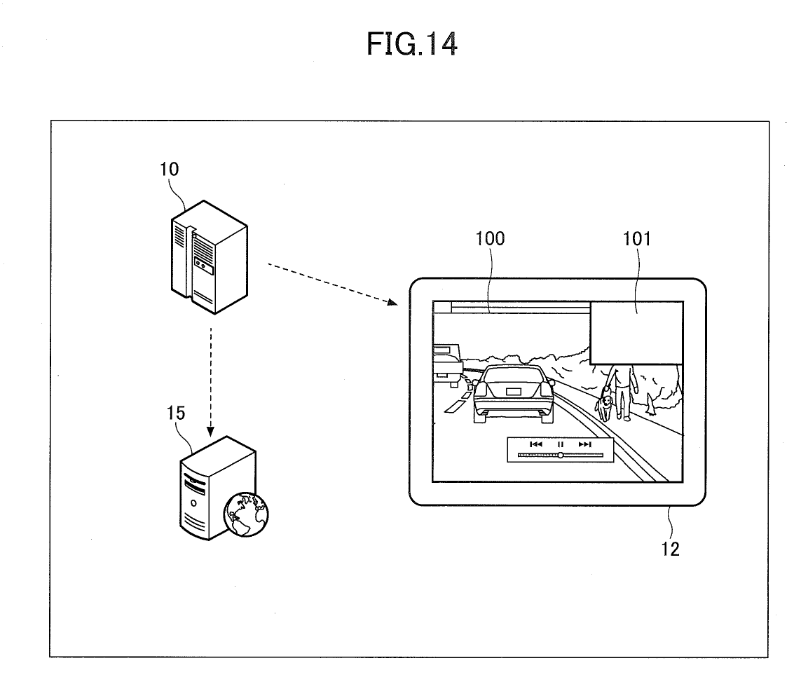

FIG. 14 is a schematic view showing an example of the operation of editing the added information into the information style corresponding to the specification of the display terminal. As shown in FIG. 14, the conference assistance server 10 delivers the added information which is edited into the information style corresponding to the specification of the display terminal 12 by the image editing device 15 to the display terminal 12. The conference assistance server 10 delivers the added information at real time or at a predetermined interval. The display terminal 12 displays an image in which the file of the presentation documents and the file of the added information are included.

The image displayed by the display terminal 12 includes a display part 100 for the presentation documents and a display part 101 for the added information. FIG. 14 shows an example where the added information is delivered to the display terminal 12, and the added information is combined in the presentation documents at the display terminal 12 side.

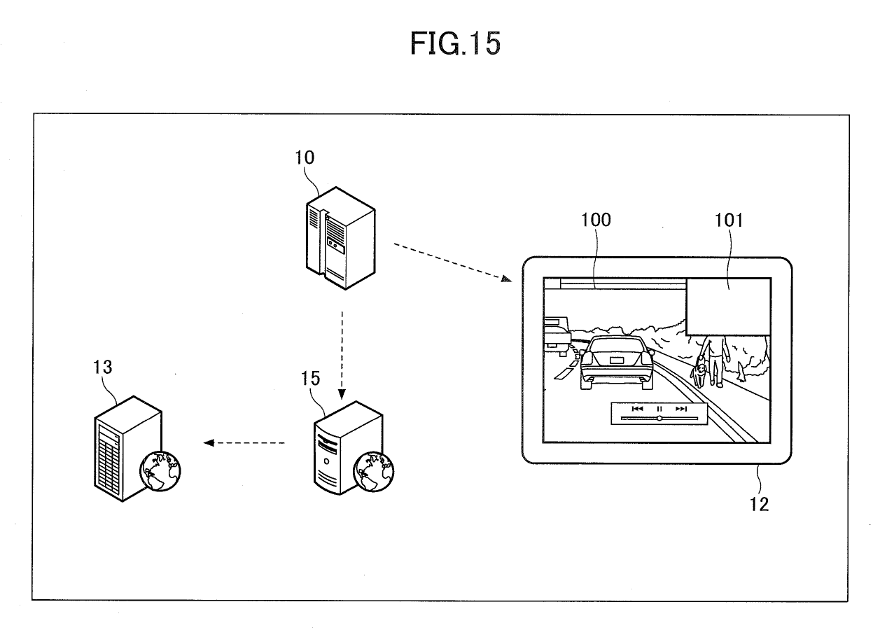

FIG. 15 is a schematic view showing another example of the operation of editing the added information into the information style corresponding to the specification of the display terminal. As shown in FIG. 15, the conference assistance server 10 delivers a file of an image, where the added information which is edited into the information style corresponding to the specification of the display terminal 12 by the image editing device 15 is combined to the presentation documents to the display terminal 12. The display terminal 12 displays the image as it is in which the added information is combined with the presentation documents.

The image displayed by the display terminal 12 includes a display part 100 for the presentation documents and a display part 101 for the added information. FIG. 15 shows an example where the image in which the added information is combined in the presentation documents is delivered to the display terminal 12, and is displayed as it is at the display terminal 12.

As described above, according to the conference assistance system 1, 2 or 3 of the embodiment, the point is how efficiently to deliver the added information to the display terminals 12. For example, for the display terminal 12 where the performance of the CPU or the capacity of the memory is small, necessary processes are done at the conference assistance server 10 side as much as possible and the time of communication is also reduced, as shown in FIG. 15. On the other hand, for the display terminal 12 where the performance is at a certain high level, the necessary processes are performed at the display terminal 12 side as shown in FIG. 14.

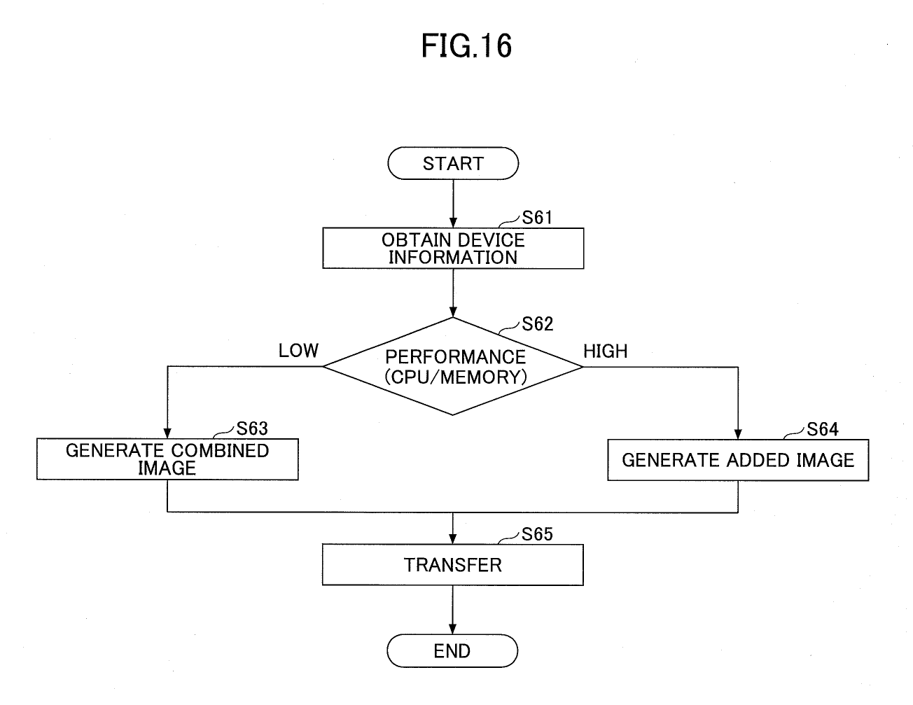

The conference assistance server 10 may determine the information style of the added information in accordance with the specification of the display terminal 12 by the process steps shown in FIG. 16, for example. FIG. 16 is a flowchart showing an example of the process steps in which the information style of the added information is determined in accordance with the specification of the display terminal. FIG. 16 shows only the different parts from the flowchart shown in FIG. 7.

In step S61, the conference assistance server 10 obtains device information of the display terminal 12 and the display input device 14. In step S62, the conference assistance server 10 determines whether the performance of the display terminal 12 is high compared with that of the display input device 14.

When the performance of the display terminal 12 is low compared with that of the display input device 14, the conference assistance server 10 generates an image in which the presentation documents and the added information are combined as shown in FIG. 15, in step S63. Then, the conference assistance server 10 transfers the image in which the presentation documents and the added information are combined to the display terminal 12 in step S65.

On the other hand, when the performance of the display terminal 12 is high compared with that of the display input device 14, the conference assistance server 10 generates an image of the added information as shown in FIG. 14, in step S64. Then, the conference assistance server 10 transfers the added information to the display terminal 12 in step S65.

According to the embodiment, the display terminals 12 held by the participants predicted to be difficult to read the added information written on the whiteboard or the like are specified. Then, the added information is delivered to the specified display terminals 12 to be displayed on the corresponding display terminals 12 so that the added information can be shared to the participants. Further, according to the embodiment, the added information is not delivered to the display terminals 12 of the participants predicted to be capable of reading the added information written on the whiteboard or the like. Therefore, unnecessary data transmitted through the network 17 can be prevented.

Further, an example of the data processing apparatus is the conference assistance server 10. An example of the calculation unit is the positional relation calculation unit 34. An example of the specifying unit is the sharing style determining unit 32. An example of the delivering unit is the communication unit 31 and the sharing style determining unit 32.

According to the embodiment, a conference assistance system, a data processing apparatus and a recording medium having recorded thereon a document delivering program capable of sharing information generated during the conference by participants are provided.

The individual constituents of the conference assistance system such as the conference assistance system 1 or the like may be embodied by arbitrary combinations of hardware and software, typified by CPU of arbitrary computer, memory, program loaded on the memory so as to embody the constituents illustrated in the drawing, storage units for storing the program such as a hard disk, and an interface for network connection. It may be understood by those skilled in the art that methods and devices for the embodiment allows various modifications.

The present invention is not limited to the specifically disclosed embodiments, and variations and modifications may be made without departing from the scope of the present invention.

The present application is based on Japanese Priority Application No. 2011-119603 filed on May 27, 2011, the entire contents of which are hereby incorporated herein by reference.

What is claimed is:

1. A conference assistance system comprising:
one or more of a display terminal that displays data of a document;
a display input device that displays added data input by a user;
a positional information obtaining device that obtains positional information of the display terminal and the display input device; and
a data processing apparatus that
calculates the positional relationship of the display terminal and the display input device based on the positional information of the display terminal and the display input device,
specifies the display terminal to which the added data is to be delivered based on the positional relationship of the display terminal and the display input device, and
delivers the added data to the specified display terminal to have the display terminal display the added data, the display terminal, the display input device, the positional information obtaining device, and the data processing apparatus being capable of communicating via a network.

2. The conference assistance system according to claim 1,
wherein the data processing apparatus specifies the display terminal as the display terminal to which the added data is to be delivered when the distance between the corresponding display terminal and the display input device exceeds a threshold value.

3. The conference assistance system according to claim 1,
wherein the data processing apparatus edits the added data into an information style suitable for the display terminal in accordance with the specifications of the display terminal and the display input device.

4. The conference assistance system according to claim 1,
wherein the data processing apparatus specifies the display terminal as the display terminal to which the added data is to be delivered when the corresponding display terminal is not included in the same area as the display input device.

5. The conference assistance system according to claim 3,
wherein the data processing apparatus delivers the added data combined in the data of the document to the display terminal and has the display terminal display the data of the document and the added data, in accordance with the specifications of the display terminal and the display input device.

6. The conference assistance system according to claim 3,
wherein the data processing apparatus delivers the added data to the display terminal and has the display terminal display the added data to be combined in the data of the document, in accordance with the specifications of the display terminal and the display input device.

7. A data processing apparatus comprising:
a calculation unit that calculates the positional relationship of one or more of a display terminal that displays data of a document and a display input device that displays added data input by a user based on the positional information of the display terminal and the display input device;
a specifying unit that specifies the display terminal to which the added data is to be delivered based on the positional relationship of the display terminal and the display input device; and
a delivering unit that delivers the added data to the specified display terminal to have the display terminal display the added data.

8. The data processing apparatus according to claim 7,
wherein the specifying unit specifies the display terminal as the display terminal to which the added data is to be delivered when the distance between the corresponding display terminal and the display input device exceeds a threshold value.

9. The data processing apparatus according to claim 7, further comprising:
a document editing unit that edits the added data into an information style suitable for the display terminal in accordance with the specifications of the display terminal and the display input device.

10. The data processing apparatus according to claim 7,
wherein the specifying unit specifies the display terminal as the display terminal to which the added data is to be delivered when the corresponding display terminal is not included in the same area as the display input device.

11. The data processing apparatus according to claim 9,
wherein the delivering unit delivers the added data combined in the data of the document to the display terminal and has the display terminal display the data of the document and the added data, in accordance with the specifications of the display terminal and the display input device.

12. The data processing apparatus according to claim 9,
wherein the delivering unit delivers the added data to the display terminal and has the display terminal display the added data to be combined in the data of the document, in accordance with the specifications of the display terminal and the display input device.

13. A non-transitory computer-readable recording medium having recorded thereon a document delivering program that causes a computer to execute modules comprising:
a calculation module that calculates the positional relationship of one or more of a display terminal that displays data of a document and a display input device that displays added data input by a user based on the positional information of the display terminal and the display input device;
a specifying module that specifies the display terminal to which the added data is to be delivered based on the positional relationship of the display terminal and the display input device; and
a delivering module that delivers the added data to the specified display terminal to have the display terminal display the added data.

14. The non-transitory computer-readable recording medium according to claim 13,
wherein the specifying module specifies the display terminal as the display terminal to which the added data is to be delivered when the distance between the corresponding display terminal and the display input device exceeds a threshold value.

15. The non-transitory computer-readable recording medium according to claim 13, further comprising:
a document editing module that edits the added data into an information style suitable for the display terminal in accordance with the specifications of the display terminal and the display input device.

16. The non-transitory computer-readable recording medium according to claim 13,
wherein the specifying module specifies the display terminal as the display terminal to which the added data is to be delivered when the corresponding display terminal is not included in the same area as the display input device.

17. The non-transitory computer-readable recording medium according to claim 15,
wherein the delivering module delivers the added data combined in the data of the document to the display terminal and has the display terminal display the data of the document and the added data, in accordance with the specifications of the display terminal and the display input device.

18. The non-transitory computer-readable recording medium according to claim 15,
wherein the delivering module delivers the added data to the display terminal and has the display terminal display the added data to be combined in the data of the document, in accordance with the specifications of the display terminal and the display input device.
